(19) United States
(12) Patent Application Publication
(10) Pub. No.: US 2023/0323173 A1
(43) Pub. Date: Oct. 12, 2023

(54) OIL RESISTANT ADHESIVE COMPOSITION

(71) Applicant: Henkel AG & Co. KGaA, Duesseldorf (DE)

(72) Inventors: Xin Wang, Shanghai (CN); Hongyu Chu, Shanghai (CN); Daoqiang Lu, Shanghai (CN); Benchi Lu, Shanghai (CN)

(21) Appl. No.: 18/325,427

(22) Filed: May 30, 2023

Related U.S. Application Data
(63) Continuation of application No. PCT/CN2020/137890, filed on Dec. 21, 2020.

(51) Int. Cl. C09J 175/08

(52) U.S. Cl. CPC C09J 175/08

(57) ABSTRACT

This invention relates to an oil resistant adhesive composition, comprising at least one crystalline polyester polyol; at least one first amorphous aromatic polyester polyol having a glass transition temperature less than 0° C.; at least one second amorphous aromatic polyester polyol having a glass transition temperature greater than or equal to 0° C.; and at least one polyisocyanate. The oil resistant adhesive composition has excellent oil resistance and can be well applied to be used in wearable devices.

### TECHNICAL FIELD

This invention relates to an oil resistant adhesive composition, comprising at least one crystalline polyester polyol; at least one first amorphous aromatic polyester polyol having a glass transition temperature less than 0° C.; at least one second amorphous aromatic polyester polyol having a glass transition temperature greater than or equal to 0° C.; and at least one polyisocyanate. The oil resistant adhesive composition has excellent oil resistance and can be well applied to be used in wearable devices.

### BACKGROUND OF THE INVENTION

Wearable devices are developing rapidly and become part of our daily life. People may enjoy music by wearing earphones, keep tracking of time via wearing electronic watches, and monitor personal health through wearable medical devices. The wearable devices are exposing to sebum all the time because they are frequently in contact with human skin which will weaken the adhesive layers formed in the devices and damage the devices.

Efforts have been made to enhance the oil resistance of adhesives. CN106398625 disclosed a hot melt adhesive using large amount of aromatic liquid polyester polyol with low glass transition temperature (T_{g}). The hot melt adhesive has good oil resistance but cannot stand severe sebum exposure. CN109666436 and CN109679559 introduced fluorine into the formulation in order to improve the oil resistance of the formulation. However, the manufacturing process is not suitable for industrial application.

Therefore, there is a need for developing an oil resistant adhesive composition has excellent tensile strength even after sebum aging under harsh condition.

### SUMMARY OF THE INVENTION

The present invention relates to an oil resistant adhesive composition, comprising:
a) at least one crystalline polyester polyol;
b) at least one first amorphous aromatic polyester polyol having a glass transition temperature less than 0° C.;
c) at least one second amorphous aromatic polyester polyol having a glass transition temperature greater than or equal to 0° C.; and
d) at least one polyisocyanate;
wherein
the amount of the first amorphous aromatic polyester polyol is from 5 to 30% by weight based on the total weight of the composition; and
the amount of the second amorphous aromatic polyester polyol is from 16 to 50% by weight based on the total weight of the composition.

The present invention also relates to a production method of the oil resistant adhesive composition.

The present invention also relates to a cured product of the oil resistant adhesive composition.

The cured oil resistant adhesive composition has excellent tensile strength even after sebum aging under harsh condition.

The present invention also relates to an article bonded by or coated with the cured product of the oil resistant adhesive composition.

### DETAILED DESCRIPTION OF THE INVENTION

In the following passages the present invention is described in more detail. Each aspect so described may be combined with any other aspect or aspects unless clearly indicated to the contrary. In particularly, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

The recitation of numerical end points includes all numbers and fractions subsumed within the respective ranges, as well as the recited end points.

All references cited in the present specification are hereby incorporated by reference in their entirety.

Unless otherwise defined, all terms used in the disclosing the invention, including technical and scientific terms, have the meaning as commonly understood by one of the ordinary skill in the art to which this invention belongs to. By means of further guidance, term definitions are included to better appreciate the teaching of the present invention.

In the context of this disclosure, a number of terms shall be utilized.

The term “crystalline” refers to a state in which polymers are at least partially regularly arranged, and polymers possesses a crystalline melting point (Tₘ) as determined by differential scanning calorimetry (DSC).

The term “amorphous” refers to a state in which molecular chains of the polymers are randomly arranged, and polymers lacking a crystalline melting point as determined by differential scanning calorimetry (DSC).

The term “crystalline melting point” (Tₘ) refers to a temperature at which crystalline segments of the polymer melt determined by differential scanning calorimetry (DSC). In the present invention, samples are first heated to 120° C. and equilibrated at 120° C. for 5 min, cooled down to −70° C. and equilibrated for 10 min at −70° C. Samples are heated to 120° C. again from −70° C. at a rate of 20° C./min. The presence of an endothermic peak during the second heating step, i.e., during the heating from −70° C. to 120° C. indicates the presence of a melt transition. The peak value of the endothermic peak is recorded as the crystalline melting point.

The term “glass transition temperature” (T_{g}) refers to a temperature at which a polymer transitions between a highly elastic state and a glassy state determined by differential scanning calorimetry (DSC). In the present invention, samples are first heated to 120° C. and equilibrated at 120° C. for 5 min, cooled down to −70° C. and equilibrated for 10 min at −70° C. Samples are heated to 120° C. again from −70° C. at a rate of 20° C./min. The presence of a step increase in heat flow during the second heating from −70° C. to 120° C. indicates the presence of a glass transition. The glass transition temperature is defined as the temperature at which the heat flow is at the midpoint of the step change.

The term “polyol component” refers to all polyols which contain at least two hydroxyl groups per molecule.

### Crystalline Polyester Polyol

The oil resistant adhesive composition of the present invention comprises at least one crystalline polyester polyol. The crystalline polyester polyol may be obtained by polymerizing at least one polycarboxylic acid (such as maleic acid, succinic acid, adipic acid, glutaric acid and the like) with at least one low molecular weight polyol (such as ethylene glycol, 1,4-butane diol, 1,6-hexane diol, 1,8-octanediol and the like). Suitable crystalline polyester polyols include but are not limited to poly(hexanediol adipate) polyol, poly(butanediol adipate) polyol, poly(hexanediol dodecanedioate) polyol, poly(hexanediol adipic acid terephthalate) polyol, and any combination thereof.

In some embodiments of the present invention, the crystalline polyester polyol preferably has a crystalline melting point from 20 to 150° C., more preferably from 30 to 120° C., and even more preferably from 50 to 100° C.

In some embodiments of the present invention, the crystalline polyester polyol preferably has a number average molecular weight of 700 g/mol or more, such as 1000 g/mol, 3000 g/mol, 5000 g/mol and 10000 g/mol measured by GPC according to DIN 55672-1 with THF as the eluent.

Examples of commercially available crystalline polyester polyol are, for example, Dynacoll 7330, 7340, 7360, 7380 from Evonik; and HS 2H-351A from Hokoku Corporation.

In some embodiments of the present invention, the amount of the crystalline polyester polyol is preferably from 10 to 50%, more preferably from 20 to 46%, and even more preferably 30 to 40% by weight based on the total weight of the oil resistant adhesive composition.

### Amorphous Aromatic Polyester Polyol

The oil resistant adhesive composition of the present invention comprises at least one first amorphous aromatic polyester polyol having a glass transition temperature less than 0° C. and at least one second amorphous aromatic polyester polyol having a glass transition temperature greater than or equal to 0° C. The amorphous aromatic polyester polyols have at least one aromatic ring per molecule in the structure (for example, in the backbone or in a side chain, if present, or in both backbone and side chain).

The amorphous aromatic polyester polyol is preferably obtained by the reaction of at least one aromatic carboxylic acid (such as phthalic acid, isophthalic acid, terephthalic acid, hexahydroisophthalic acid and the like) with at least one polyol (such as 1,4-butane diol, 1,6-hexane diol, 1,8-octanediol and the like). Suitable amorphous aromatic polyester polyols include but are not limited to polyalkylene phthalate, polyalkylene isophthalate and polyalkylene terephthalate.

In some embodiments of the present invention, the first amorphous aromatic polyester polyol preferably has a glass transition temperature from −65 to −5° C., more preferably from −55 to −10° C., and even more preferably from −30 to −20° C.

In some embodiments of the present invention, the first amorphous aromatic polyester polyol preferably has a number average molecular weight of 500 g/mol or more, such as 1000 g/mol, 3000 g/mol, 5000 g/mol and 10000 g/mol measured by GPC according to DIN 55672-1 with THF as the eluent.

Examples of commercially available first amorphous aromatic polyester polyol are, for example, DYNACOLL 7210, 7230, and 7231 from Evonik; and STEPANPOL PH56, PDP70 from Stepan Company.

In some embodiments of the present invention, the amount of the first amorphous aromatic polyester polyol is preferably from 5 to 30%, more preferably from 10 to 20%, and even more preferably from 10 to 17% by weight based on the total weight of the oil resistant adhesive composition.

In some embodiments of the present invention, the second amorphous aromatic polyester polyol preferably has a glass transition temperature from 0 to 50° C., more preferably from 5 to 40° C., and even more preferably from 20 to 35° C.

In some embodiments of the present invention, the second amorphous aromatic polyester polyol preferably has a number average molecular weight of 500 g/mol or more, such as 1000 g/mol, 3000 g/mol, 5000 g/mol and 10000 g/mol measured by GPC according to DIN 55672-1 with THF as the eluent.

Examples of commercially available second amorphous aromatic polyester polyol are, for example, DYNACOLL 7130 and 7140 from Evonik; and HS 2F-136P, HS 2F-306P, and HS 2H-458T from Hokoku Corporation.

In some embodiments of the present invention, the amount of the second amorphous aromatic polyester polyol is preferably from 16 to 50%, more preferably from 16 to 30%, and more preferably from 20 to 25% by weight based on the total weight of the oil resistant adhesive composition.

It is surprisingly found that it is critical to incorporate both the first amorphous aromatic polyester polyol and the second amorphous aromatic polyester polyol in the composition in order to improve the oil resistant property.

In some embodiments, it is also important to control the total amount of the first and second amorphous aromatic polyester polyols to be from 25% to 35% by weight based on the total weight of the oil resistant adhesive composition to achieve a desirable viscosity from 8000 to 11000 mPa·s at 110° C.

### Polyisocyanate

The oil resistant adhesive composition of the present invention comprises at least one polyisocyanate which has at least two isocyanate groups (—NCO) per molecule. Suitable polyisocyanates include but are not limited to aromatic, aliphatic, alicyclic or cycloaliphatic polyisocyanates, and can be selected, for example, from 4,4′-diphenylmethane diisocyanate (MDI), hydrogenated MDI, partly hydrogenated MDI, xylylene diisocyanate (XDI), tetramethylxylylene diisocyanate (TMXDI), 4,4′-diphenyldimethylmethane diisocyanate, 4,4′-dibenzyl diisocyanate, 1,3-phenylene diisocyanate, 1,4-phenylene diisocyanate, the isomers of toluylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), tetramethoxybutane-1,4-diisocyanate, naphthalene-1,5-diisocyanate (NDI), tolidine diisocyanate (TODI), p-phenylene diisocyanate (PPDI) and 4-bromo-metaphenylene diisocyanate, butane-1,4-diisocyanate, hexane-1,6-diisocyanate (HDI), 2,2,4-trimethylhexane-2,3,3-trimethylhexamethylene diisocyanate, cyclohexane-1,4-diisocyanate, ethylene diisocyanate, methylenetriphenyltriisocyanate (MIT), phthalic acid bisisocyanatoethyl ester, trimethylhexamethylene diisocyanate, 1,4-diisocyanatobutane, 1,12-diisocyanatododecane, and dimer fatty acid diisocyanate, lysine ester diisocyanate, 4,4-dicyclohexylmethane diisocyanate (H12MDI), 1,3-cyclohexane or 1,4-cyclohexane diisocyanate (CHDI), and any combination thereof. Preferably, the polyisocyanate is selected from MDI, HDI, CHDI, NDI, H12MDI and any combination thereof.

Examples of commercially available polyisocyanates, for example, are Desmodur 0118I, N-3900 and 44C from Covestro.

In some embodiments of the present invention, the amount of the polyisocyanates is from 10 to 25%, and preferably from 10 to 20% by weight based on the total weight of the oil resistant adhesive composition.

### Optional Additives

The oil resistant adhesive composition may further comprise optional additives. The selection of suitable additives for the oil resistant adhesive composition of the invention depends on the specific intended use of the oil resistant adhesive composition and can be determined in the individual case by those skilled in the art.

### <Polyether Polyol>

The oil resistant adhesive composition of the present invention may optionally comprise at least one polyether polyol having at least two hydroxyl groups per molecule. The polyether polyol may be any common polyether polyol known in the art and can be obtained by polymerizing at least one epoxide (such as ethylene oxide, propylene oxide, butylene oxide and the like) with at least one low molecular weight polyol (such as water, propylene glycol, ethylene glycol, glycerine, trim ethylolpropane and the like) as an initiator. Suitable polyether polyols include but are not limited to polypropylene glycol (PPG), polyethylene glycol (PEG), polytetrahydrofuran glycol, polytetram ethylene glycol, and any combination thereof.

In some embodiments, the polyether polyol preferably has a number average molecular weight of 100 g/mol or more, such as 400 g/mol, 1000 g/mol, 2000 g/mol, 4000 g/mol and 10000 g/mol measured by GPC according to DIN 55672-1 with THF as the eluent.

Examples of commercially available polyether polyol are, for example, Voranol P400, P725, P1000, 2120P and 2110 TB from Dow; and Acclaim 4200 from Bayer.

In some embodiments of the present invention, the amount of the polyether polyol is from 0 to 30%, and preferably from 2 to 20% by weight based on the total weight of the oil resistant adhesive composition.

### <Amorphous Non-Aromatic Polyester Polyol>

The oil resistant adhesive composition of the present invention may optionally comprise at least one amorphous non-aromatic polyester polyol known in the art. The term “non-aromatic” used herein means that there is no aromatic group in the molecule. It may be produced by polycondensation from at least one polyol (such as propylene glycol, ethylene glycol, trimethylolpropane and the like) with at least one polycarboxylic acid (such as succinic acid, adipic acid, sebacic acid, azelaic acid and the like).

In some embodiments of the present invention, the amorphous non-aromatic polyester polyol preferably has a number average molecular weight of 100 g/mol or more, such as 400 g/mol, 1000 g/mol, 2000 g/mol, 4000 g/mol and 10000 g/mol measured by GPC according to DIN 55672-1 with THF as the eluent.

In some embodiments of the present invention, the amorphous non-aromatic polyester polyol preferably has a glass transition temperature from −65 to 20° C., preferably from −60 to 0° C., and even more preferably from −58 to −45° C.

Example of commercially available amorphous non-aromatic polyester polyol is, for example, Dynacoll 7250 from Evonik.

In some embodiments of the present invention, the amount of the amorphous non-aromatic polyester polyol is from 0 to 20%, and preferably from 5 to 15% by weight based on the total weight of the oil resistant adhesive composition.

### <Catalyst>

The oil resistant adhesive composition of the present invention may optionally comprise at least one catalyst to control the reaction speed between polyisocyanate and the polyol component. Suitable catalysts include but are not limited to organometallic catalysts and amine catalysts, such as stannous octoate, triethylenediamine, N-ethyl morpholine, and dim ethylethylethanolamine.

Examples of commercially available catalysts are, for example, Jeffcat DMDEE from Huntsman; and TOYOCAT ET-33B from Tosoh Corporation.

In some embodiments of the present invention, the amount of the catalyst is from 0 to 3%, and preferably from 0.1 to 2% by weight based on the total weight of the oil resistant adhesive composition.

### <Antioxidant>

The oil resistant adhesive composition of the present invention may optionally comprise at least one antioxidant to protect the polyurethane which is formed by reacting polyisocyanate with polyol component from aging.

Examples of commercially available antioxidants are, for example, Irganox 245 and 1010 from BASF; and Evernox 10 from Everspring Chemical.

In some embodiments of the present invention, the amount of the antioxidant is from 0 to 5%, and preferably from 0.01 to 3% by weight based on the total weight of the oil resistant adhesive composition.

### <Fluorescent Brightener>

The oil resistant adhesive composition of the present invention may optionally comprise at least one fluorescent brightener. The fluorescent brightener includes but is not limited to benzoxazole derivatives, bis-benzoxazoles; bisbenzoxazolyl-stilbenes; bis-benzoxazolyl-thiophenes, thiophenediyl benzoxazoles, 2,5-thiophenediylbis-(5-tert-butyl-1,3-benzoxazoles). The fluorescent brightener can be used alone or in combination.

Examples of commercially available fluorescent brightener are, for example, Tinpol OB CO and Uvitex OB from BASF.

In some embodiments of the present invention, the amount of the fluorescent brightener is from 0 to 2%, and preferably from 0.01 to 1% by weight based on the total weight of the oil resistant adhesive composition.

Other optional additives that may be used in the oil resistant adhesive composition of the present invention, include but are not limited to fillers; biocides; dyes; pigments; and the mixtures thereof.

In a preferred embodiment, the oil resistant adhesive composition comprises:
(a) from 10 to 50% by weight of at least one crystalline polyester polyol;
(b) from 5 to 30% by weight of at least one first amorphous aromatic polyester polyol having a glass transition temperature less than 0° C.;
(c) from 16 to 50% by weight of at least one second amorphous aromatic polyester polyol having a glass transition temperature greater than or equal to 0° C.;
(d) from 10 to 25% by weight of at least one polyisocyanate;
(e) from 0 to 30% by weight of at least one polyether polyol;
(f) from 0 to 20% by weight of at least one amorphous non-aromatic polyester polyol;
(g) from 0 to 3% by weight of at least one catalyst;
(h) from 0 to 5% by weight of at least one antioxidant; and
(i) from 0 to 2% by weight of at least one fluorescent brightener;
wherein the weight percentages of all components add up to 100% by weight.

The molar ratio between isocyanate group (—NCO) from polyisocyanate and hydroxyl group (—OH) group from polyol component in the oil resistant adhesive composition of the present invention is preferably from 1.2 to 4 and more preferably from 1.5 to 2.5.

A person skilled in the art will be able to make appropriate choices among the varies components based on the description, representative examples and guidelines of the present invention to prepare a composition to achieve desired effects.

The oil resistant adhesive composition of the present invention may be prepared by steps of:
a) mixing at least one crystalline polyester polyol, at least one first amorphous aromatic polyester polyol and at least one second amorphous aromatic polyester polyol together at an elevated temperature, such as from 100 to 150° C., under vacuum in a reactor with continuous stirring to obtain melt polyol components;
b) introducing at least one polyisocyanate into the reactor and allowing the melt polyol components and polyisocyanates to react at an elevated temperature, such as from 90 to 140° C., under vacuum; and
c) optionally adding at least one catalyst to the reactor to speed up the reaction between the melt polyol components and polyisocyanates.

The other optional additives may be added to the reactor in step a) during blending if desired to be included in the oil resistant adhesive composition.

In some embodiments of the present invention, a viscosity from 4000 to 15000 mPa·s at 110° C. is generally acceptable for the oil resistant adhesive composition. However, for easy processing of the oil resistant adhesive composition, the viscosity is more preferably to be from 8000 to 11000 mPa·s at 110° C.

The oil resistant adhesive composition of the present invention may be applied to a substrate surface via a scarper, a sprayer, a dispenser or an extruder, and allowed to be cured at a temperature from 10 to 35° C. and a relativity humidity greater than or equal to 30%.

The cured product of the oil resistant adhesive composition exhibits excellent tensile strength even after exposed to sebum.

The oil resistant adhesive composition of the present invention is particularly useful to be used in wearable devices and handheld digital devices.

### EXAMPLES

The present invention will be further described and illustrated in detail with reference to the following examples. The examples are intended to assist one skilled in the art to better understand and practice the present invention, however, are not intended to restrict the scope of the present invention. All numbers in the examples are based on weight unless otherwise stated.

### Example 1-10

The following materials were used in the examples.

Voranol 2120P (Polyether polyol with a Mn of 2000 from Dow);

Voranol 2110 TB (Polyether polyol with a Mn of 1000 from Dow);

Dynacoll 7250 (Amorphous non-aromatic polyester polyol with a Mn of 5500 g/mol and Tg of −56° C. from Evonik);

Dynacoll 7330 (Crystalline polyester polyol with a Mn of 3500 g/mol and Tm of 85° C. from Evonik);

Dynacoll 7360 (Crystalline polyester polyol with a Mn of 3500 g/mol and Tm of 58° C. from Evonik);

Dynacoll 7340 (Crystalline polyester polyol with a Mn of 3500 g/mol and Tm of 96° C. from Evonik);

Dynacoll 7231 (Amorphous aromatic polyester polyol with a Mn of 3500 g/mol and Tg of −30° C. from Evonik);

STEPANPOL PH56 (Amorphous aromatic polyester polyol with a Mn of 2000 g/mol and Tg of −22° C. from Stepan Company);

STEPANPOL PDP70 (Amorphous aromatic polyester polyol with a Mn of 1600 g/mol and Tg of −54° C. from Stepan Company);

Dynacoll 7130 (Amorphous aromatic polyester polyol with a Mn of 3000 g/mol and Tg of 29° C. from Evonik);

Dynacoll 7140 (Amorphous aromatic polyester polyol with a Mn of 5500 g/mol and Tg of 26° C. from Evonik);

Jeffcat DMDEE (2,2′-dimorpholinodiethylether from Huntsman);

Evernox 10 (Pentaerythritol Tetrakis (3-(3,5-di-tert-butyl-4-hydroxyphenyl)propionate) from Everspring Chemical);

Tinpol OB CO (Benzoxazol from BASF); and

Desmodur 0118 ((Methylene Diphenyl Di-Isocyanate from Covestro).

The oil resistant adhesive compositions were prepared as Examples (Ex.) using the components according to Table 1 by steps of:
a) mixing all polyols including polyether polyols (Voranol 2120P and Voranol 2110 TB), crystalline polyester polyols (Dynacoll 7330, Dynacoll 7360, and Dynacoll 7340), amorphous aromatic polyester polyols (Dynacoll 7231, STEPANPOL PH56, STEPANPOL PDP70, Dynacoll 7130, and Dynacoll 7140), and amorphous non-aromatic polyester polyols (Dynacoll 7250) together with an antioxidant (Evernox 10) and a fluorescent brightener (Tinpol OB CO) in a steel reactor under vacuum (50 mbar) at 140° C. with stirring at a speed of 120 rpm for 2 hours;
b) reducing the temperature in the steel reactor to 120° C.;
c) adding polyisocyanates (Desmodur 0118 I) into the steel reactor and keeping the reaction under vacuum at 120° C. with stirring at a speed of 120 rpm for 1 hour;
d) breaking down the vacuum by introducing nitrogen gas into the steel reactor;
e) adding a catalyst (Jeffcat DMDEE) into the steel reactor and keeping the reaction under vacuum (50 mbar) at 120° C. with stirring at a speed of 120 rpm for 10 minutes; and
f) downloading the oil resistant adhesive composition samples and storing the samples in a sealed can.

The oil resistant adhesive composition samples were then subjected to various tests and the results were reported in Table 2 and 3.

TABLE 1
Oil resistant adhesive composition

| | Weight (%) | | | | | | | | | |
|---|---|---|---|---|---|---|---|---|---|---|
| Component | Ex. 1 | Ex. 2 | Ex. 3 | Ex. 4 | Ex. 5 | Ex. 6 | Ex. 7 | Ex. 8 | Ex. 9 | Ex. 10 |
| Voranol 2120P | 4.75 | 17 | 10 | 6 | 10.48 | 2 | 7 | 2 | 6 | 0 |
| Voranol 2110 TB | 6 | 0 | 0 | 0 | 17.2 | 12.5 | 0 | 16.27 | 0 | 19.27 |
| Dynacoll 7250 | 12 | 0 | 0 | 6.97 | 12 | 12 | 11 | 12 | 7 | 9.64 |
| Dynacoll 7330 | 5.35 | 5.5 | 5.5 | 5.35 | 5.35 | 5.35 | 5.35 | 5.35 | 5.31 | 5.35 |
| Dynacoll 7360 | 17.13 | 20 | 20 | 17.13 | 17.13 | 17.13 | 17.13 | 17.13 | 17.00 | 17.13 |
| Dynacoll 7340 | 10.71 | 11 | 20 | 10.71 | 10.71 | 10.71 | 10.71 | 10.71 | 10.70 | 10.71 |
| Dynacoll 7231 | 10 | 0 | 0 | 15 | 10 | 10 | 20 | 20 | 0 | 12.85 |
| STEPANPOL PH56 | 0 | 10 | 0 | 0 | 0 | 0 | 0 | 0 | 0 | 0 |
| STEPANPOL PDP70 | 0 | 3 | 13 | 0 | 0 | 0 | 0 | 0 | 0 | 0 |
| Dynacoll 7130 | 20 | 0 | 0 | 25 | 0 | 15 | 15 | 0 | 40 | 7.49 |
| Dynacoll 7140 | 0 | 18.5 | 16.5 | 0 | 0 | 0 | 0 | 0 | 0 | 0 |
| Jeffcat DMDEE | 0.11 | 0.11 | 0.11 | 0.11 | 0.11 | 0.11 | 0.11 | 0.11 | 0.11 | 0.11 |
| Evernox 10 | 0.05 | 0.05 | 0.05 | 0.05 | 0.05 | 0.05 | 0.05 | 0.05 | 0.05 | 0.05 |
| Tinpol OB CO | 0.05 | 0.05 | 0.05 | 0.05 | 0.05 | 0.05 | 0.05 | 0.05 | 0.05 | 0.05 |
| Desmodur 0118 I | 13.85 | 14.79 | 14.79 | 13.63 | 16.92 | 15.10 | 13.60 | 16.33 | 13.78 | 17.35 |

Test Methods

<Viscosity>

The viscosity of the oil resistant adhesive composition sample was determined at 110° C. using a Brookfield Thermosel viscometer and a spindle number 27.

<Tensile Strength of the Oil Resistant Adhesive Composition without Sebum Exposure>

The oil resistant adhesive composition sample was dispensed at 120° C. and applied onto a first PC/ABS substrate (CYCOLOY C1200HF from Sabic) forming two straight adhesive stripes on the surface. A second PC/ABS substrate was laid over the first PC/ABS substrate. The bond line thickness of each adhesive stripe in between the two substrates was controlled to be about 100 μm, and the width and length of each adhesive stripe were controlled to be about 1.5 mm and 25.4 mm respectively. The oil resistant adhesive composition sample was allowed to be cured at room temperature (23° C.±2° C.) and 50% relative humidity for 7 days, and then placed at room temperature (23° C.±2° C.) and 50% relative humidity for 1 day before tensile strength testing.

The tensile strength of the cured oil resistant adhesive composition sample was determined using Instron Universal test machine 5969 and 1 kN Load Cell with a head speed of 2 mm/min. Five samples were tested and the average tensile strength (T) were reported in Table 3.

<Tensile Strength of the Oil Resistant Adhesive Composition after Sebum Exposure>

The oil resistant adhesive composition sample was dispensed at 120° C. and applied onto a first PC/ABS substrate (CYCOLOY C1200HF from Sabic) forming two straight adhesive stripes on the surface. A second PC/ABS substrate was laid over the first PC/ABS substrate. The bond line thickness of each adhesive stripe in between the two substrates was controlled to be about 100 μm, and the width and length of each adhesive stripe were controlled to be about 1.5 mm and 25.4 mm respectively. The oil resistant adhesive composition sample was allowed to be cured at room temperature (23° C.±2° C.) and 50% relative humidity for 7 days.

Sebum (contents: palm itic acid 10%, stearic acid 5%, coconut oil 15%, paraffin wax 10%, synthetic spermaceti 15%, olive oil 20%, squalene 5%, cholesterol 5%, oleic Acid 10%, and linoleic acid 5%, available from Scientific Services S/D, Inc) was melt at 50° C., and was uniformly applied to the cured adhesive stripes in between the two PC/ABS substrates every day for 7 days so that the two cured adhesive stripes were fully soaked in the sebum under an aging condition of 55° C. and 50% relative humidity. The bonded PC/ABS substrates together with the aged oil resistant adhesive composition sample were kept at room temperature (23° C.±2° C.) and 50% relative humidity for 1 day before tensile strength testing.

The tensile strength of the aged oil resistant adhesive composition sample was determined using Instron Universal test machine 5969 and 1 kN Load Cell with a head speed of 2 mm/min. Five samples were tested and the average tensile strength (Ts) were reported in Table 3.

<Decay Ratio of the Tensile Strength>

The decay ratio of the tensile strength (DR) was calculated by the following formula:

DR=Tₛ/T*100%

It was only accepted if the value of DR was greater than or equal to 70%.

Test Results

TABLE 2
Viscosity (mPa · s)

| Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|
| 10400 | 9500 | 9700 | 12000 | 5200 | 9000 | 9300 | 7100 | 17800 | 5500 |

The viscosities of the oil resistant adhesive composition samples are reported in Table 2. The viscosities for Ex.1 to 4 were acceptable, but the viscosities for Ex.1 to 3 were more desirable when the total amount of the amorphous aromatic polyester polyol was controlled to be from 25% to 35% by weight based on the total weight of the oil resistant adhesive composition so that the viscosities of the oil resistant adhesive compositions were between 8000 to 11000 mPa·s.

TABLE 3
Tensile Strength (MPa)

| | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| Tensile strength without | 7.37 | 7.10 | 6.88 | 7.03 | 6.69 | 6.89 | 7.52 | 7.37 | 6.2 | 7.46 |
| sebum exposure (T) | | | | | | | | | | |
| Tensile strength after | 5.21 | 5.17 | 5.13 | 5.17 | 3.47 | 4.00 | 4.83 | 4.54 | 3.15 | 4.16 |
| sebum exposure (Tₛ) | | | | | | | | | | |
| Decay ratio (DR) | 71% | 73% | 75% | 74% | 52% | 58% | 64% | 62% | 51% | 56% |

The tensile strengths of the oil resistant adhesive composition samples are reported in Table 3. The decay ratio of the tensile strength (DR) was found to be low if only the first amorphous aromatic polyester polyol or the second amorphous aromatic polyester polyol was presented in the composition as demonstrated by Ex. 5, Ex. 8 and Ex.9. Further, when the amount of the second amorphous aromatic polyester polyol was low (Ex.6, Ex.7 and Ex.10) in the composition, the DR was also not good.

What is claimed is:

1. An oil resistant adhesive composition comprising:
a) at least one crystalline polyester polyol;
b) 5 to 30% by weight based on the total weight of the composition of at least one first amorphous aromatic polyester polyol having a glass transition temperature less than 0° C.;
c) 16 to 50% by weight based on the total weight of the composition of at least one second amorphous aromatic polyester polyol having a glass transition temperature greater than or equal to 0° C.; and
d) at least one polyisocyanate; and
wherein the weight percentages of all components add up to 100% by weight.

2. The oil resistant adhesive composition according to claim 1, wherein the crystalline polyester polyol has a crystalline melting point from 50 to 100° C.

3. The oil resistant adhesive composition according to claim 1, wherein crystalline polyester polyol has a number average molecular weight greater than or equal to 700 g/mol.

4. The oil resistant adhesive composition according to claim 1, wherein the first amorphous aromatic polyester polyol has a glass transition temperature from −30 to −20° C.

5. The oil resistant adhesive composition according to claim 1, wherein the amount of the first amorphous aromatic polyester polyol is from 10 to 17% by weight based on the total weight of the composition.

6. The oil resistant adhesive composition according to claim 1, wherein the first amorphous aromatic polyester polyol has a number average molecular weight greater than or equal to 500 g/mol.

7. The oil resistant adhesive composition according to claim 1, wherein the second amorphous aromatic polyester polyol has a glass transition temperature from 20 to 35° C.

8. The oil resistant adhesive composition according to claim 1, wherein the amount of the second amorphous aromatic polyester polyol is from 20 to 25% by weight based on the total weight of the composition.

9. The oil resistant adhesive composition according to claim 1, wherein the second amorphous aromatic polyester polyol has a number average molecular weight greater than or equal to 500 g/mol.

10. The oil resistant adhesive composition according to claim 1, wherein the total amount of first and second amorphous aromatic polyester polyols is from 25% to 35% by weight based on the total weight of the oil resistant adhesive composition.

11. The oil resistant adhesive composition according to claim 1, wherein the polyisocyanate is selected from MDI, HDI, CHDI, NDI, H12MDI and any combination thereof.

12. The oil resistant adhesive composition according to claim 1, further comprising at least one polyether polyol, and/or at least one amorphous non-aromatic polyester polyol, and/or at least one catalyst, and/or at least one antioxidant, and/or at least one fluorescent brightener, and/or at least one filler.

13. The oil resistant adhesive composition according to claim 1, comprising:
(a) from 10 to 50% by weight of at least one crystalline polyester polyol;
(b) from 5 to 30% by weight of at least one first amorphous aromatic polyester polyol having a glass transition temperature less than 0° C.;
(c) from 16 to 50% by weight of at least one second amorphous aromatic polyester polyol having a glass transition temperature greater than or equal to 0° C.;
(d) from 10 to 20% by weight of at least one polyisocyanate;
(e) from 0 to 30% by weight of at least one polyether polyol;
(f) from 0 to 20% by weight of at least one amorphous non-aromatic polyester polyol;
(g) from 0 to 3% by weight of at least one catalyst;
(h) from 0 to 5% by weight of at least one antioxidant; and
(i) from 0 to 2% by weight of at least one fluorescent brightener;
wherein the weight percentages of all components add up to 100% by weight.

14. A production method of the oil resistant adhesive of claim 1, comprising steps of:
a) mixing at least one crystalline polyester polyol, at least one first amorphous aromatic polyester polyol and at least one second amorphous aromatic polyester polyol at an elevated temperature under vacuum in a reactor with continuous stirring to obtain melt polyol components;
b) introducing at least one polyisocyanate into the reactor and allowing the melt polyol components and polyisocyanates to react at an elevated temperature under vacuum; and
c) optionally adding at least one catalyst to the reactor.

15. Cured reaction products of the oil resistant adhesive composition according to claim 1.

16. An article coated with or bonded by the cured reaction products of the oil resistant adhesive composition according to claim 1.
